(19) United States
(12) Patent Application Publication
(10) Pub. No.: US 2013/0182433 A1
(43) Pub. Date: Jul. 18, 2013

(54) LIGHTING APPARATUS

(71) Applicants: Toru Okazaki, Osaka (JP); Toshihiro Ohya, Osaka (JP); Toshio Mori, Hyogo (JP); Yoshio Manabe, Osaka (JP)

(72) Inventors: Toru Okazaki, Osaka (JP); Toshihiro Ohya, Osaka (JP); Toshio Mori, Hyogo (JP); Yoshio Manabe, Osaka (JP)

(73) Assignee: PANASONIC CORPORATION, Osaka (JP)

(21) Appl. No.: 13/823,489

(22) PCT Filed: Oct. 14, 2011
(86) PCT No.: PCT/JP2011/005753

§ 371 Date: Mar. 14, 2013

(30) Foreign Application Priority Data
Dec. 8, 2010 (JP) 2010-274095

(51) Int. Cl. F21V 13/04

(52) U.S. Cl. CPC F21V 13/04
USPC 362/235

(57) ABSTRACT

A lighting apparatus includes a light source including a plurality of solid-state light-emitting elements, each of which emits light using a semiconductor; a shielding body that includes an opening that allows only a part of the light emitted from the light source to pass through; a lens that converts the light allowed to pass through the opening into spotlight; and a reflecting body that is provided between the lens and the shielding body and reflects the light that is traveling in a direction diverged from the lens, to reach the lens.

### TECHNICAL FIELD

The present invention relates to lighting apparatuses that generate spotlight used at studios, as stage installations, for storefront display, and the like.

### BACKGROUND ART

Conventionally, lighting apparatuses are available in which a plurality of solid-state light-emitting elements, such as light emitting diodes (LEDs) each emits light using a semiconductor, are arranged as a light source for the purpose of reducing heat generation and saving power consumption. The configuration of such lighting apparatuses is similar to the configuration of the lighting apparatuses which include, as light sources, conventional light bulbs each emits light using filaments. For such a lighting apparatus, the configuration is adopted in which light emitted from the light source is allowed to pass through an opening of a shielding body and the light allowed to pass through the opening is collected by a lens to be emitted as spotlight (See Patent Literature (PTL) 1, for example).

Such a lighting apparatus allows the light emitted from each of the solid-state light-emitting elements to overlap at the opening of the shielding body, which makes it possible to reduce unevenness in light distribution.

### CITATION LIST

### Patent Literature

[PTL 1] Japanese Unexamined Patent Application Publication No. 2009-004276

### SUMMARY OF INVENTION

### Technical Problem

However, with the aforementioned lighting apparatus which includes the light source including solid-state light-emitting elements, it was sometimes difficult to obtain an expected amount of spotlight with respect to the amount of power applied, when a configuration is adopted in which reduction of unevenness in color and light distribution of the generated spotlight is taken into consideration.

As a result of wholehearted investigation and experiments, the inventors of the present invention found that the light emitted from the light source tends to be Lambertian light distribution, and therefore a part of the light allowed to pass through the opening of the shielding body does not reach the lens and thus is not used effectively as spotlight.

The present invention has been conceived in view of the above knowledge, and has a primary object to provide a lighting apparatus which can generate a sufficient amount of spotlight while taking reduction of unevenness in light distribution and color into consideration.

The inventors of the present invention also found that the lighting apparatus that can achieve the above object tends to increase in weight which causes problems in changing the position of the spotlight.

The present invention has been conceived in view of the above knowledge, and has a secondary object to provide a lighting apparatus that can secure heat resistance performance of the entire apparatus while reducing weight.

### Solution to Problem

In order to achieve the above object, a lighting apparatus according to the present invention includes: a light source including a plurality of solid-state light-emitting elements each of which emits light using a semiconductor; a shielding body that includes an opening that allows only a part of the light emitted from the light source to pass through; a lens that converts the light allowed to pass through the opening into spotlight; and a reflecting body that is provided between the lens and the shielding body and reflects the light that is traveling in a direction diverged from the lens, to reach the lens.

With this, it is possible to provide a lighting apparatus which increases the amount of spotlight even when an equivalent amount of power is applied.

It is preferable that a length of the reflecting body in a direction along an optical axis of the lens is greater than or equal to a diameter of the lens and less than a distance between the lens and the shielding body.

This allows securing a sufficient amount of generated spotlight while making the size of the reflecting body appropriate, which can reduce the weight of the entire lighting apparatus.

In a positional relationship in a direction along an optical axis of the lens, a position of an end portion of the reflecting body may be the same as a position of the lens.

With this, the reflecting body does not contact the shielding body directly. Therefore, it is possible to avoid an adverse effect such as the reflecting body distorting due to heat conducted from the shielding body.

The reflecting body includes: a base body including resin; and a reflective film that is provided on a surface of the base body and reflects light.

With this, it is possible to reduce the weight of the entire lighting apparatus without taking into consideration the effect of heat conducted from the shielding body.

A plurality of the solid-state light-emitting elements of the light source may be arranged in a same plane, and optical axes of the solid-state light-emitting elements may be arranged along a direction perpendicular to the plane on which the solid-state light-emitting elements are arranged. The opening may have a size that allows the light emitted from the light source to pass through the opening without a gap, and may be provided at a position that allows the light to pass through the opening without a gap, and a center of the opening to overlap with an optical axis of the light source.

With this, it is possible to minimize the unevenness in color between a center portion and a peripheral portion of spotlight while securing a sufficient amount of light. Accordingly, it is possible to illuminate spotlight which can provide a clear and sharp impression for a viewer who views a portion illuminated with the spotlight.

It is preferable that, when a distance shortest among distances from a point on the light source to an end of an arrangement region is defined as a shortest distance, an opening length that is a distance longest among distances from the center of the opening to an end of the opening is within a range of 0.5 to 0.8 times the shortest distance, the point being a point at which a virtual axis that passes through the center of the opening arrives along the optical axis of the light source, the arrangement region being a region in which the solid-state light-emitting elements are arranged.

Adopting the shielding body having an opening of the above opening length provides a lighting apparatus which reduces unevenness in color between a center portion and a peripheral portion of spotlight while illuminating a sufficient amount of spotlight.

### Advantageous Effects of Invention

With the lighting apparatus according to the present invention, it is possible not only to illuminate a sufficient amount of spotlight while saving power consumption, but also to make operation of spotlight easier due to the lightness in weight.

### BRIEF DESCRIPTION OF DRAWINGS

FIG. 1 is a plan view from a cross section showing an internal configuration of a lighting apparatus.

FIG. 2 is a perspective view showing an outlook of the lighting apparatus.

FIG. 3 is a plan view showing a planar light source from a direction light is emitted.

FIG. 4 is a plan view from a cross section showing a relationship between an opening and the planar light source.

FIG. 5 is a schematic diagram showing a relationship between an arrangement region and an opening of the light source by illustrating virtually the arrangement region and the opening in the same plane.

FIG. 6 is a graph showing a relationship between a radius of the opening and color difference amount (magnitude of color unevenness) when a shortest distance is set to be constant.

FIG. 7 is a graph showing a relationship between the radius of the opening and a light utilization ratio when the shortest distance is set to be constant.

FIG. 8 is a graph showing a relationship between a length of a reflecting body and spotlight illuminance.

FIG. 9 is a plan view from a cross section showing a surface structure of the reflecting body.

FIG. 10 is a plan view from a cross section showing a lighting apparatus according to another embodiment.

### DESCRIPTION OF EMBODIMENTS

### Embodiment 1

The following describes embodiments of the lighting apparatus according to the present invention with reference to the Drawings. It is to be noted that the embodiments below merely show an example of the lighting apparatus according to the present invention. Accordingly, the scope of the present invention is determined by the wording in Claims with reference to the embodiments below, and is not limited to the embodiments only.

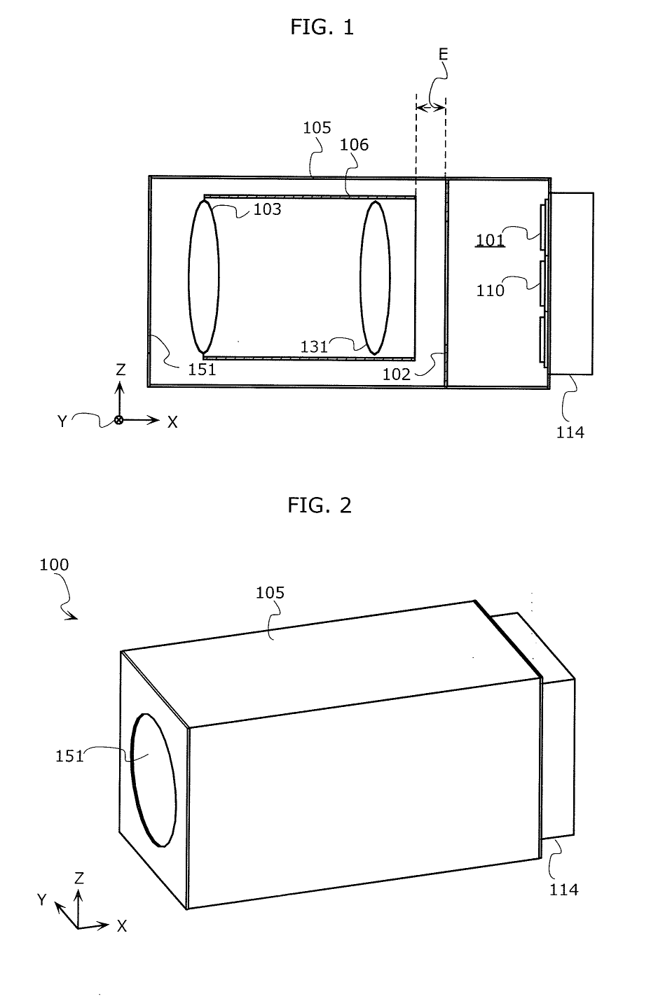

FIG. 1 is a plan view from a cross section showing an internal configuration of a lighting apparatus.

FIG. 2 is a perspective view showing an outlook of the lighting apparatus.

As shown in these drawings, a lighting apparatus 100 includes a light source 101, a shielding body 102, a lens 103, a reflecting body 106, and a case 105.

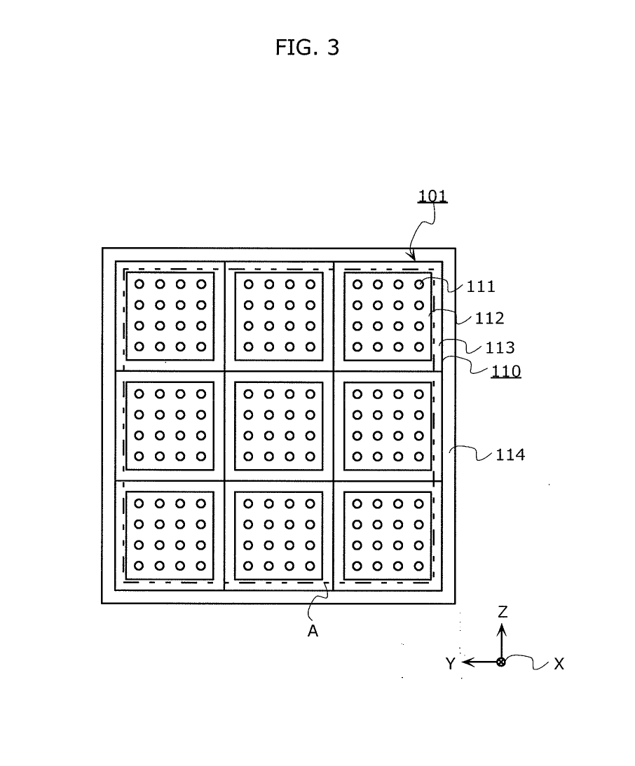

FIG. 3 is a plan view showing a light source from a direction light is emitted.

The light source 101 includes a plurality of solid-state light-emitting elements 111 in a plane (YZ plane in the drawing). Each of the solid-state light-emitting elements 111 emits light using a semiconductor.

The solid-state light-emitting element 111 can be a light emitting diode (LED) or an organic EL device, for example. A specific example of the solid-state light-emitting element 111 includes a blue LED chip or the like that emits blue light. Gallium nitride semiconductor solid-state light-emitting element including InGaN material and has a center wave length of 450 [nm] to 470 [nm] can be used as a blue LED chip.

An organic EL may also be used as the solid-state light-emitting element 111. For example, the solid-state light-emitting element 111 can be configured with a three color light emitting organic EL including: a bis(1-phenyl-isoquinoline) iridium acetylacetonate [pq2Ir(acac)] light emitting layer of a phosphorescent dopant that emits red light; a tris(2-phenylpyridinato) iridium(III) light emitting layer that emits green light; and a tertiary butyl phosphine (TBP) light emitting layer that emits blue light.

In the present embodiment, the light source 101 includes a plurality of light-emitting modules 110 arranged in a matrix. The light-emitting module 110 includes: a substrate 113, a plurality of solid-state light-emitting elements 111 mounted on the surface of the substrate 113 in a matrix, and a phosphor containing member 112 provided at a side opposite from the substrate 113 with respect to the solid-state light-emitting elements 111 (a side to which light is emitted). Furthermore, the light-emitting modules 110 are arranged so that the solid-state light-emitting elements 111 are arranged not on a curved surface but on the same flat surface.

Configuring the light source 101 with the light-emitting modules 110 in the above manner makes it possible to generate a large amount of spotlight by using versatile light-emitting modules 110 which are used: for a light for household use, for example. Furthermore, using the light-emitting modules 110 placed on the flat surface of the substrate 113 simplifies the configuration of the light-emitting module 110 itself, which facilitates and reduces costs for manufacturing of the light source 101.

The phosphor containing member 112 is a member which emits a color applicable for lighting, such as white light, by causing the phosphor to absorb a part of the light from the solid-state light-emitting element 111 that emits light of a single color and causing the phosphor to generate a light having a wavelength different from the light from the solid-state light-emitting element 111, and mixing the light from the solid-state light-emitting elements 111 and the light from the phosphor. The phosphor containing member 112 exists in a state that the phosphor is dispersed on transparent or translucent resin. Furthermore, the phosphor containing member 112 has a function to seal the solid-state light-emitting element 111 in order to protect the solid-state light-emitting element 111 from the air and humidity.

It is to be noted that (i) the sealing member for coating the solid-state light-emitting element 111 and (ii) the phosphor containing member 112 may be separated, and their material is not limited to resin. An example includes transparent material such as glass that is known as material for chip sealing.

Furthermore, the phosphor included in the phosphor containing member 112 is a light wavelength conversion member including fine particles or the like. As the phosphor, for example, when the solid-state light-emitting element 111 is a blue LED, a yellow phosphor fine particles are used preferably to obtain white light. An example of the yellow phosphor includes yttrium, aluminum, and garnet (YAG) phosphor material, and silicate phosphor material. Furthermore, as an example of resin that supports the phosphor in a dispersed state, silicone resin can be raised.

The substrate 113 is a rectangle board member, and the solid-state light-emitting elements 111 are mounted on the surface. For example, the substrate 113 is a substrate of ceramic such as aluminum oxide or the like. It is to be noted that material of the substrate 113 is not limited and may be resin, glass, or the like, as long as the material has an insulation property. Furthermore, the substrate 113 is not limited to a rigid body but may be a flexible substrate having flexibility.

Furthermore, in the light source 101, the solid-state light-emitting elements 111 are arranged in such a manner that the optical axis goes along a direction of an axis vertical to a YZ plane (X axis). With the above arrangement of the solid-state light-emitting elements 111, the light source 101 has, as a whole, an optical axis that goes along a direction of the axis vertical to the YZ plane (X axis) and passes through a center portion of an arrangement region A of the solid-state light-emitting elements 111.

Here, the optical axis is an axis that virtually connects the position of the light source and a position of the strongest light out of the light emitted. Specifically, the axis indicating orientation of the solid-state light-emitting elements 111 and the axis indicating orientation of the light source 101 is the optical axis.

Furthermore, as shown in FIGS. 1 and 2, the light source 101 is attached with a heat radiating unit 114. The heat radiating unit 114 is for releasing, into the air, heat generated when the light source 101 emits light. An example of the heat radiating unit 114 includes: a heat releasing body that has a plurality of fins on a board member in contact with the light source 101; and a fan which generates air flow that passes between the fins of the heat releasing body to allow efficient heat exchange between the fin and the air.

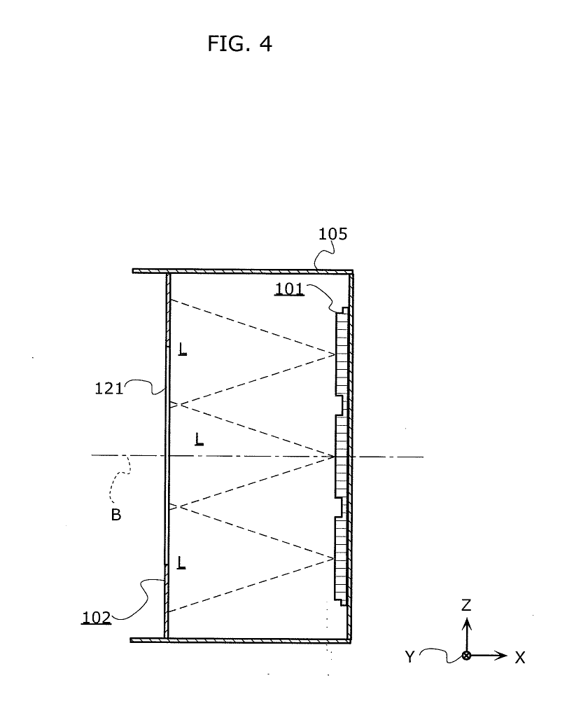

FIG. 4 is a plan view from a cross section showing a relationship between the opening of the shielding body and the light source.

The shielding body 102 is a board member so-called an aperture, and includes an opening 121 that allows only a part of light emitted from the light source 101 to pass through. In the present embodiment, the shielding body 102 includes the opening 121 having a size that allows a light L, that is emitted from each of the solid-state light-emitting elements 111 of the light source 101, to pass through the opening 121 without a gap, and is being provided at a position that allows the light emitted from the light source 101 to pass through the opening 121 without a gap and allowing the center of the opening 121 to match the optical axis B of the light source 101.

Adopting the above size of the opening 121 and the positional relationship between the light source 101 and the opening 121 makes it possible to reduce the color unevenness in the generated spotlight. In particular, although there is a large non light-emitting portion between one light-emitting module 110 and another light-emitting module 110 adjacent to the one light-emitting module 110 in the light source 101 including the light-emitting modules 110 arranged as in the present embodiment, color unevenness in the spotlight can be reduced due to the size that allows the light L to pass through the opening 121 without a gap and the positional relationship.

The shielding body 102 is a thin board member and is provided with an opening 121 that is a hole penetrates through the shielding body 102 in a thickness direction. Furthermore, at least a side of the shielding body 102 close to the light source 101 is applied with processing to minimize reflection (matte black paint, black plating, or the like). Furthermore, in the present embodiment, the opening 121 is circular and the light source 101 and the opening 121 are arranged parallely.

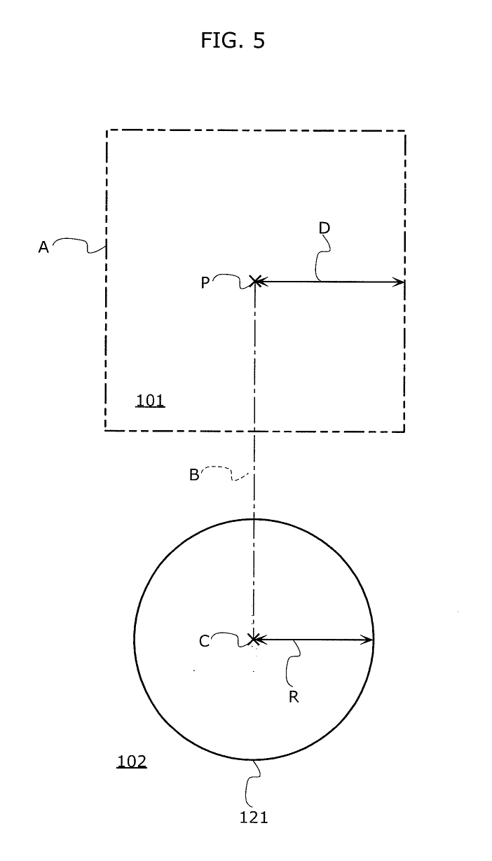

FIG. 5 is a schematic diagram showing a relationship between an arrangement region of the light source and the opening by illustrating virtually the arrangement region and the opening in the same plane.

As shown in FIG. 5, it is preferable that, when a distance shortest among distances from a point P on the light source 101 to an end of an arrangement region A is defined as a shortest distance D, an opening length R (radius, in the present embodiment) that is a distance longest among distances from the center C of the opening 121 to an end of the opening 121 satisfies the expression below, the point P being a point at which a virtual axis B that passes through the center C of the opening 121 arrives along the optical axis B of the light source 101, the arrangement region A being the region in which the solid-state light-emitting elements 111 are arranged.

0.5D≦R≦0.8D

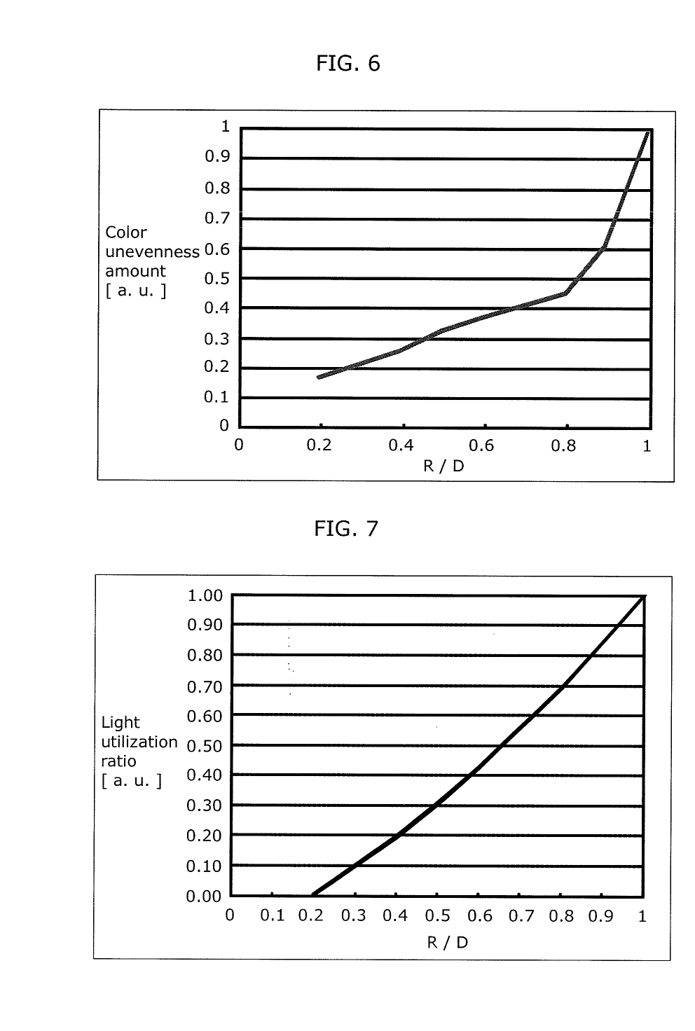

The opening length R is shorter than or equal to 0.8 times the shortest distance D. This is because, as shown in the graph in FIG. 6, the color difference amount between the center portion and the peripheral portion of spotlight exceeds 0.5 (a. u.) and deteriorates drastically when the opening length R is longer than 0.8 times the shortest distance D.

Here, the point where the color difference amount is evaluated in the peripheral portion is a point having an illuminance that is 1/10 the illuminance of the center portion.

Furthermore, the color difference amount is an absolute value (kelvin) of a change amount between the color of the center portion and the color of the peripheral portion when the color difference amount of the color of the center portion of spotlight is defined as zero. The graph in FIG. 6 shows a result of a relative comparison on the color difference amount at each R/D, when the color difference amount between the center portion and the peripheral portion where R/D=1 is defined as 1.

The opening length R is longer than or equal to 0.5 times the shortest distance D. This is because, as shown in the graph in FIG. 7, the light utilization ratio decreases to less than or equal to 30% which means a required amount of light as spotlight cannot be obtained, when the opening length R is shorter than or equal to 0.5 times the shortest distance D.

It is to be noted that the graph in FIG. 7 shows a result of a relative comparison on an amount of light that is actually taken in the lens 103 from the light source 101 (effective beam) at each R/D, when the effective beam where R/D=1 is defined as 1.

Furthermore, the color difference occurs between the center portion and the peripheral portion in a region in which the light source 101 emits light to a distant position. This is because of: a specification in emitting light as spotlight to a distant position by the lens 103; and Lambertian light distribution by the light source 101. Specifically, the color component which is emitted by the light source 101 and turns from blue to red is allowed to pass through the lens 103, which causes a difference between the refractive indexes of color components turning from blue to red at the lens 103. Therefore, the color difference between the center portion and the peripheral portion occurs in principle in the light-emitting region. In the case where the light source 101 is of Lambertian light source, the color difference is even greater. To reduce the color difference between the center portion and the peripheral portion of the spotlight to less than or equal to 0.5 (a. u.), it is sufficient to keep the color component which turns from blue to red of the light source 101 constant before the light is incident to the lens 103, by providing the shielding body 102 between the lens 103 and the light source 101 that is the Lambertian light source. The color difference occurs regardless of the position and the size of the lens, and the color difference amount between the center portion and the peripheral portion of the spotlight can be reduced to less than or equal to 0.5 (a. u.) if the above relationship, 0.5D≦R≦0.8D, can be satisfied.

The lens 103 converts the light allowed to pass through the opening 121, that is the light emitted using the opening 121 as a pseudo light source, into spotlight. In the present embodiment, the lighting apparatus 100 includes, in addition to the lens 103 for generating spotlight, a second lens 131 provided between the lens 103 and the opening 121. The second lens 131 has a function to equalize (reduce graininess of) the light after passing through the second lens 131, by blurring (diffusing) the light emitted from each of the solid-state light-emitting elements 111. Accordingly, the lens 103 generates spotlight using the light equalized by the second lens 131. Material for the lens 103 and the second lens 131 is not specifically limited. However, it is possible to reduce weight of the lighting apparatus 100 by adopting a lens including resin such as acrylic, polycarbonate, or the like. Furthermore, the lens 103 and the second lens 131 are attached to the case 105 so that the optical axes of the lens 103 and the second lens 131 match the optical axis of the light source 101 that passes through the center of the opening 121.

The reflecting body 106 is provided between the lens 103 and the shielding body 102, and is a member that reflects the light traveling in a direction diverged from the lens 103 so that the light reaches the lens 103.

In the present embodiment, as shown in FIG. 1, the reflecting body 106 is a cylindrical member, and the length of the reflecting body 106 in the direction along the optical axis of the lens 103 (X-axis direction in the drawing) is greater than or equal to the diameter of the lens 103 and shorter than the distance between the lens 103 and the shielding body 102. Specifically, when the diameter of the lens 103 is less than 150 mm, the distance between the lens 103 and the shielding body 102 is approximately 200 mm for example, although it depends also on the focal point distance of the lens 103. Accordingly, the length of the reflecting body 106 in the direction along the optical axis of the lens 103 is within a range of 150 mm to 200 mm.

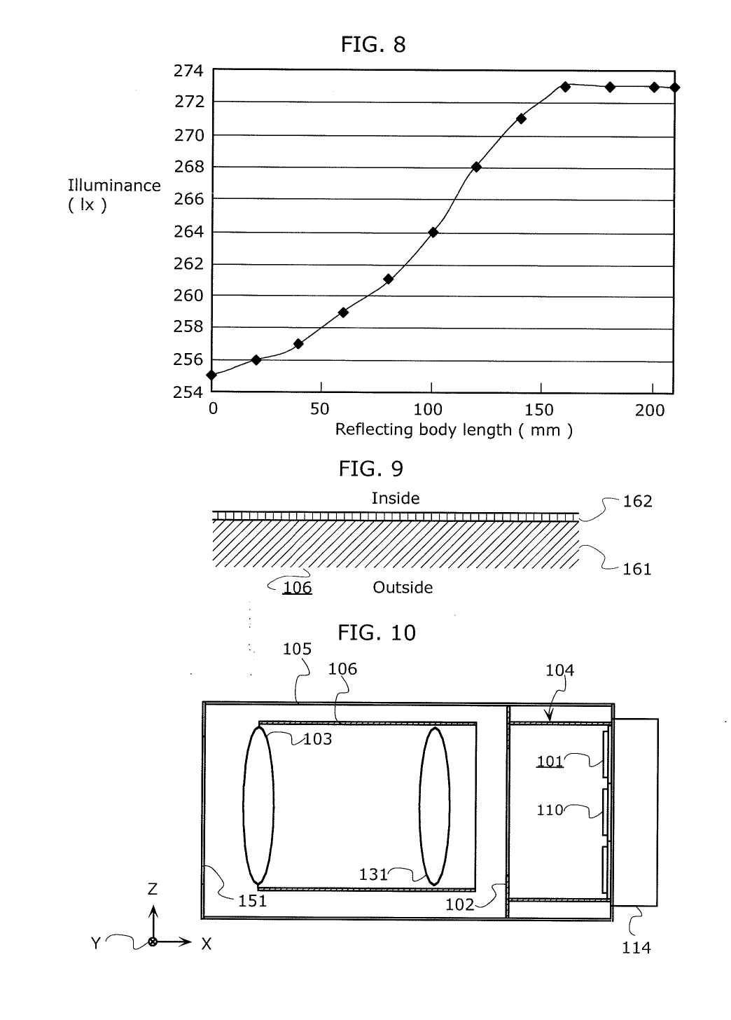

Limiting the length of the reflecting body 106 in this manner makes it possible to secure a sufficient amount of light (illuminance) of generated spotlight with respect to the case where the reflecting body 106 is not included (when reflecting body length is 0) as shown in FIG. 8, while suppressing the increase in weight of the lighting apparatus 100 because of the reflecting body 106.

Furthermore, as shown in FIG. 1, a position of an end portion of the reflecting body 106 at a side closer to the through hole 151 is the same as the position of the lens 103, in the positional relationship in a direction along the optical axis of the lens 103 (X-axis direction). Here, “the same” includes the substantially same position, and therefore the case where the end portion of the reflecting body 106 is displaced back and forth in some degree with respect to the position of the lens 103 is also included in the “same” position.

Providing the reflecting body 106 in the above manner allows most of the light traveling in a direction diverged from the lens 103, out of the light traveling using the opening 121 as the pseudo light source, to reach the lens 103 due to reflection. It also allows to provide a space E between the shielding body 102 and the reflecting body 106, which reduces the effect on the reflecting body 106 caused by heat of the shielding body 102.

Accordingly, a base body 161 that is the structural basis for the reflecting body 106 (see FIG. 9) can be made of resin, such as polycarbonate or the like. This allows the reflecting body 106 to be provided, on the surface of the base body 161, with a reflective film 162 that reflects light.

Furthermore, it is possible to prevent heat from staying inside the reflecting body 106, which reduces the effect of heat on the lens 103, the second lens 131, and the like. Accordingly, resin lens can be adopted.

The lighting apparatus 100 including the above-described resin reflecting body 106 is light in weight and can secure a sufficient amount of light with respect to an amount of power applied, and can be used for a long time since the reflecting body 106 is kept away from the effect of heat.

It is to be noted that the reflective film 162 can be provided for the resin base body 161 in arbitrary ways. An example includes: attaching on the base body 161 foil or sheet made of metal such as aluminum; forming a film made of metal or the like on the base body 161 by performing vapor-deposition; and insert-molding the base body 161 with resin film having a reflex function.

Furthermore, the reflecting body 106 is not limited to be a cylindrical shape but may be a tube having a cross-section in a shape other than a circle. Furthermore, a part of the reflecting body 106 may be cut out, and the reflecting body 106 may be provided with a hole.

The case 105 is a member which has an empty space to store the light source 101, the shielding body 102, and the lens 103. In the present embodiment, the case 105 is in a prism shape having a rectangle cross-section. One end portion onto which the light source 101 is provided is closed by the heat radiating unit 114 or the like, and the other end is provided with a through hole 151 for illuminating spotlight. It is preferable that the case 105 is formed of metal painted in matte black or resin.

Using the above-described lighting apparatus 100 makes it possible to reduce unevenness in light distribution and color and generate a sufficient amount of spotlight, while reducing weight of the lighting apparatus 100 itself. Furthermore, the reflecting body 106 of the lighting apparatus 100 is not easily affected by heat since heat conduction via the shielding body 102 is blocked by the space E. In particular, even when a light-weight resin reflecting body 106 is used, it is possible to reduce change or deterioration over time, such as the reflective film 162 partially detaching or coming off from the base body 161.

Furthermore, since light emitted from the light source 101 is allowed to pass through the opening 121 without a gap, color unevenness in the spotlight illuminated through the lens 103 is minimized, and the border can be viewed clearly.

It is to be noted that the present invention is not limited to the above embodiment. For example, another embodiment obtained by optionally combining the constituent elements described in the present description or by removing some of the constituent elements described in the present description may be the embodiment of the present invention. Any variations of the present embodiment to be conceived by those skilled in the art without departing from the spirit of the present invention, that is, the meaning of the wording in the claims, are also within the scope of the present invention.

For example, the light source 101 is not limited to the light source 101 having the light-emitting modules 110, and may be the light source 101 provided with the solid-state light-emitting elements 111 on a single substrate. Furthermore, the arrangement region A in which the solid-state light-emitting elements 111 are arranged is not limited to a square and may be in arbitrary shapes such as a circle.

Furthermore, the lighting apparatus 100 may include a driving circuit that causes the light source 101 to emit light.

Furthermore, as shown in FIG. 10, a reflector 104 may be provided between the light source 101 and the shielding body 102.

The reflector 104 is a member that reflects light emitted from the light source 101, to guide the light to the opening 121. The reflector 104 is provided between the light source 101 and the shielding body 102 symmetrically with respect to the optical axis B of the light source 101, having the light source 101 therebetween.

The reflector 104 is formed with four flat-plate members arranged to surround the light source 101 along the outer edge of the light source 101, and mirror surface treatment is applied on the faces facing each other. Furthermore, the reflector 104 is provided to cover the space from the light source 101 to the shielding body 102, and guides, to the opening 121 of the shielding body 102, the light from each of the solid-state light-emitting elements 111 of the light source 101 stored inside an end portion of the reflector 104.

As described above, by further providing the reflector 104 for the lighting apparatus 100, the light source 101 is stored in the reflector 104. Therefore, the light which does not directly reach the opening 121, out of the light emitted from each of the solid-state light-emitting elements 111, can be reflected once or multiple of times in the reflector 104 to reach the opening 121. Thus, the amount of light allowed to pass through the opening 121 increases, which makes it possible to further improve the illumination efficiency of the lighting apparatus 100.

It is to be noted that the reflector 104 can improve the illumination efficiency as two board mirrors facing each other, not necessarily surround the perimeter of the light source 101 entirely. Furthermore, even when the arrangement region A is rectangle, the reflector 104 may be in a cylindrical shape, not necessarily along the outline of the light source 101. Furthermore, the reflector 104 is not limited to those reflect light regularly but may be those reflect light irregularly.

### INDUSTRIAL APPLICABILITY

The lighting apparatus according to the present invention can be used as: so-called spotlight used at a stage or a TV studio; an apparatus for lighting up buildings; an apparatus for storefront display; and the like.

### REFERENCE SIGNS LIST

100 Lighting Apparatus
101 Light source
102 Shielding body
103 Lens
104 Reflector
105 Case
106 Reflecting body
110 Light-emitting module
111 Solid-state light-emitting element
112 Phosphor containing member
113 Substrate
114 Heat radiating unit
121 Opening
131 Second lens
151 Through hole
161 Base body
162 Reflective film
A Arrangement region
B Optical axis
C Center
D Shortest distance
E Space
L Light
P Point
R Opening length
X Axial direction

1. A lighting apparatus comprising:
a light source including a plurality of solid-state light-emitting elements each of which emits light using a semiconductor;
a shielding body that includes an opening that allows only a part of the light emitted from the light source to pass through;
a second lens that diffuses the light emitted from the light source through the shielding body;
a first lens that converts the light allowed to pass through the opening into spotlight; and
a reflecting body that is provided between the first lens and the shielding body and reflects the light that is emitted through the second lens and is traveling in a direction diverged from the first lens, to reach the first lens.

2. The lighting apparatus according to claim 1,
wherein a length of the reflecting body in a direction along an optical axis of the lens is greater than or equal to a diameter of the lens and less than a distance between the lens and the shielding body.

3. The lighting apparatus according to one of claim 1,
wherein in a positional relationship in a direction along an optical axis of the lens, a position of an end portion of the reflecting body is the same as a position of the lens.

4. The lighting apparatus according to claim 3,
wherein the reflecting body includes:
a base body including resin; and
a reflective film that is provided on a surface of the base body and reflects light.

5. The lighting apparatus according to claim 1, to claim 1,
wherein a plurality of the solid-state light-emitting elements of the light source are arranged in a same plane, and optical axes of the solid-state light-emitting elements are arranged along a direction perpendicular to the plane on which the solid-state light-emitting elements are arranged, and
the opening has a size that allows the light emitted from the light source to pass through the opening without a gap, and is provided at a position that allows the light to pass through the opening without a gap, and a center of the opening to overlap with an optical axis of the light source.

6. The lighting apparatus according to claim 5,
wherein when a distance shortest among distances from a point on the light source to an end of an arrangement region is defined as a shortest distance, an opening length that is a distance longest among distances from the center of the opening to an end of the opening is within a range of 0.5 to 0.8 times the shortest distance, the point being a point at which a virtual axis that passes through the center of the opening arrives along the optical axis of the light source, the arrangement region being a region in which the solid-state light-emitting elements are arranged.
